(19) United States
(12) Patent Application Publication
(10) Pub. No.: US 2005/0160605 A1
(43) Pub. Date: Jul. 28, 2005

(54) Food cutter and method

(76) Inventors: Timothy C. Poole, Florence, AL (US); Carter W. McGuyer, Muscle Schoals, AL (US); Rodney W. Robbins, Florence, AL (US)

Correspondence Address: Gregor N. Neff, Esq.;c/o Kramer Levin Naftalis & Frankel LLP, 919 Third Avenue, New York, NY, 10022, US

(21) Appl. No.: 10/762,414

(22) Filed: Jan. 22, 2004

(51) Int. Cl. B26B 3/00

(52) U.S. Cl. 30/115

(57) ABSTRACT

A measuring cutter for food in block form, such as butter. The cutter has a blade with measurement marks spaced from one another in a first direction, and a cutting edge perpendicular to that direction. The food block is aligned with a measurement mark, and the cutter is pivoted about the cutting edge and thrust downwardly so as to sever a predetermined quantity of butter from the bar in a single stroke. Preferably, the cutting blade is as wide as or wider than the width of the block being cut.

This invention relates to food cutters and methods, and particularly to cutters and methods for cutting solid foods in block form, such as butter, shortening, margarine, cheese, etc. The invention particularly relates to devices and methods for cutting and separating measured quantities of such foods from the blocks.

The measurement of the quantities of certain foods sold in blocks, such as butter, margarine, shortening, etc., long has presented problems. Packing the material into a measuring cup or spoon is possible only if the food is soft enough. This, of course, takes time, and requires the washing of the measuring cups or spoons after use.

Measuring and cutting a length of food in elongated rectangular block form is a simple way of measuring the quantity required, except that a measuring scale must be made available and used.

Certain devices are available for both storing and cutting of measured quantities of butter. Such devices use a taut wire cut through the butter to sever a measured quantity from a cube or stick of butter. Such devices work well and are satisfactory in many ways, but are less than fully satisfactory to those who do not want or need the storage capability and seek a simpler, lower cost alternative.

Another prior proposal is one in which a knife is provided with measuring marks along its blade. The distance between a mark on the blade and the tip of the blade indicates a particular quantity of material. The blade is laid on top of the butter block with a mark aligned with the edge of the block. Then, the blade is rotated to a vertical position, plunged downwardly into the block and then rotated downwardly to make a cut at the desired location. Then the knife is removed and another cut is made to sever the desired quantity block. This is relatively cumbersome and difficult to use.

Accordingly, it is an object of the present invention to provide a food cutter and method which overcome or alleviate the foregoing problems.

Specifically, it is an object of the invention to provide a cutter which is relatively simple, fast and easy to use, and is relatively inexpensive to make.

In accordance with the present invention, the foregoing objectives are satisfied by the provision of a food cutter which has a plurality of measurement marks on it which are spaced from one another in a first direction, and a cutting blade which extends in a direction transverse to the first direction. Thus, the cutter can be positioned flat on one surface of the food block to be cut, with one edge of the block aligned with a mark on the cutter, and then the cutter is simply pivoted about the cutting blade to an upright position and thrust downwardly to sever the desired quantity from the block. The blade is substantially as wide as the block so that the cut can be made with a single downward stroke.

This cutter is easy and fast to use, relatively inexpensive to manufacture, and has a relatively broad blade so that it can be used like a spatula.

The foregoing and other objects and advantages of the invention will be set forth in or apparent from the following description and drawings.

### IN THE DRAWINGS

FIG. 1 is a perspective view of a food cutter constructed in accordance with the present invention;

FIG. 2 is a top plan view showing the food cutter of FIG. 1 in use in cutting a measured quantity of butter from a butter block;

FIG. 3 is a side elevation view of the structure shown in FIG. 2;

FIG. 4 is a side elevation view of the structure shown in FIGS. 2 and 3 at the completion of a cut made with the cutter; and

FIG. 5 is a top plan view of the cutter when used in cutting from a food block of a size different from that shown in FIG. 2.

### DESCRIPTION OF THE PREFERRED EMBODIMENTS

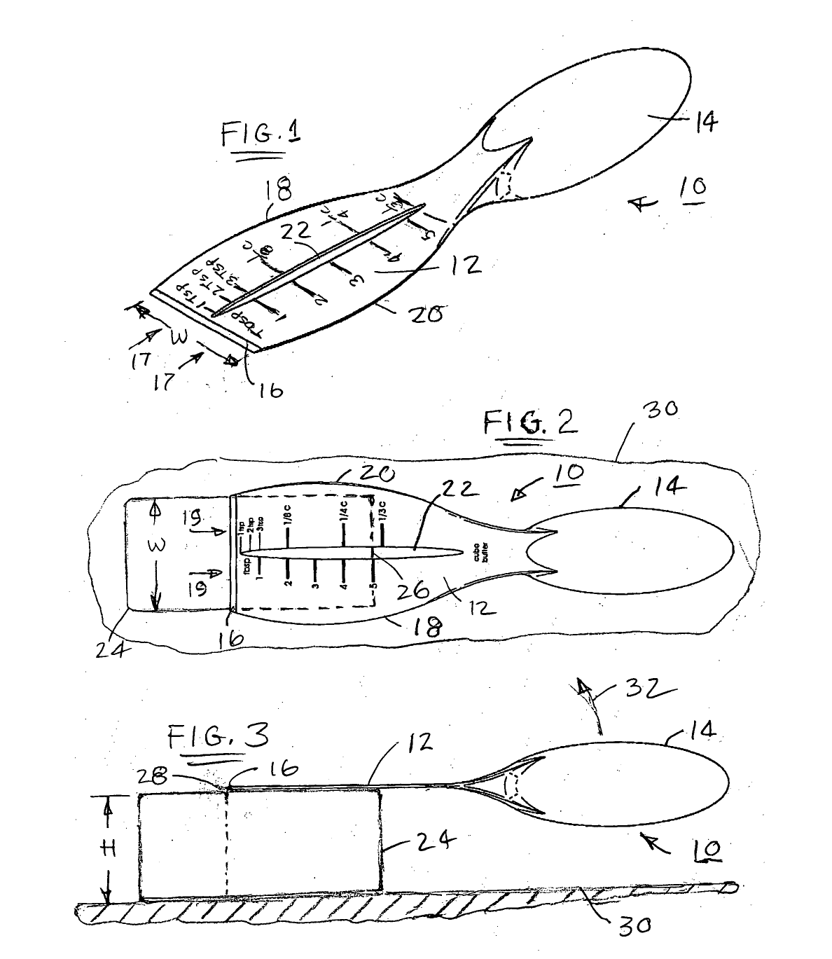

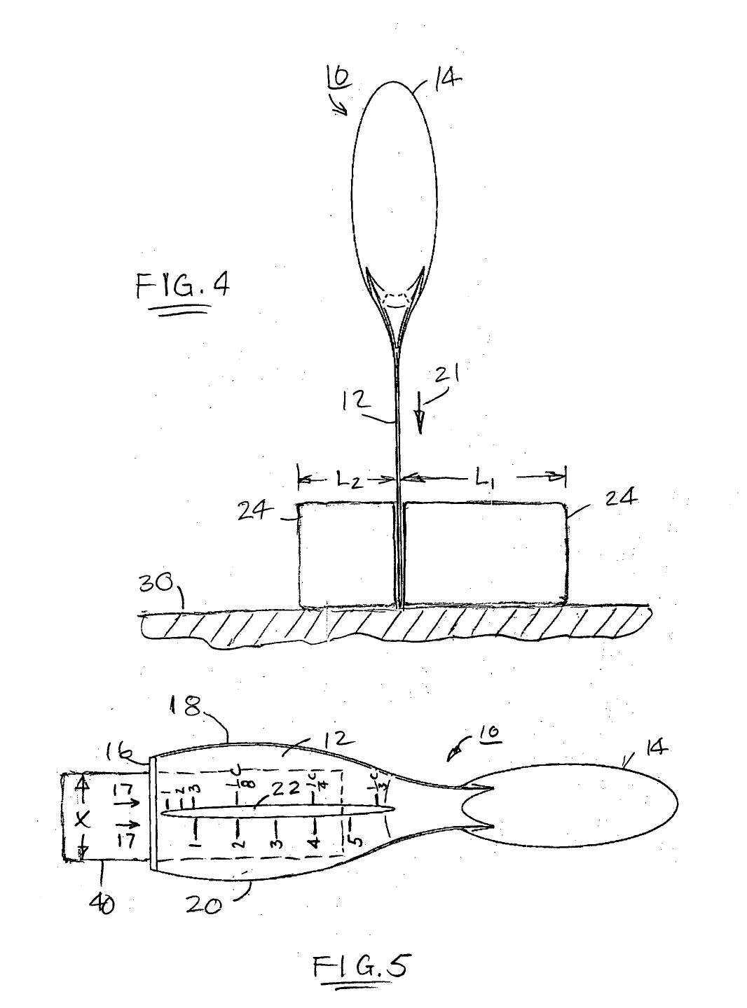

FIG. 1 is a perspective view of the food cutter 10 of the present invention. The cutter includes a flat blade 12 attached to a handle 14. The blade has side edges 18 and 20 and a cutting edge 16 at its far end. The blade 12 has an elongated slot 22 approximately in the center of the blade extending in the longitudinal direction indicated by the arrows 17.

The arrows 17 indicate arrays of measurement marks which extend in a direction substantially parallel to the cutting edge 16. The marks are spaced apart from one another in a direction perpendicular to the cutting edge 16. The marks indicate various measurements like “1 tbsp” (1 tablespoon); “1 tsp” (1 teaspoon); and “¼ c” (one quarter cup), etc.

FIG. 2 shows the opposite surface of the blade 12. It has arrays of measurement marks 19 along the central slot 22. The measurement marks 19 are for use with a food block of a size different from the size of the block for which the marks 17 on the opposite surface of the blade 12 are to be used. Again, the marks 19 are spaced from one another in the direction indicated by the arrows 19, which is transverse to the cutting edge 16.

The cutter 10 is shown in FIGS. 2 and 3 positioned with its blade on top of a block or stick of butter 24. Preferably, as shown in FIG. 2, the cutting edge 16 is at least as long as the width “W” of the butter block 24.

In use, the cutter 10 is positioned as shown in FIG. 3 flat on top of the upper surface of the block 24 and is moved until the right edge 26 of the block, as seen through the slot 22, aligns with the measurement mark showing the desired volume, e.g., five tablespoons. The cutting edge 16 of the cutter 10 then is located at a point 28 (see FIG. 3) on the surface of the butter block 24.

In order to separate five tablespoons of butter from the block 24, the user merely rotates the cutter 10 upwardly about the cutting edge 16 at point 28 on the top of the butter block in the direction indicated by the arrow 32 in FIG. 3. Then, when the cutter 10 reaches an approximately vertical position, it is thrust downwardly in the direction indicated by the arrow 21, completely through the block 24 until it reaches the surface 30 on which the butter block rests.

Thus, the butter block is separated into two different pieces, one having a length “L2” and the other a length “L1”. The volume of the length L1 is approximately five tablespoons.

Then, because the blade 12 of the cutter is relatively broad, if desired, it can be used in the manner of a spatula to insert under the butter piece L1 to another location, such as into a cooking pot or mixing bowl, etc.

The reason that the cutter 10 has different sets of markings on opposite sides of the blade 12 is to accommodate different sizes of food blocks, particularly butter. In the United States, butter is distributed in two different standard sizes; one in the western part of the country which often is called a “cube”, and a longer, narrower block which is sold in the eastern part of the United States and often is called a “stick”. If desired, the side of the blade that bears the marks 17 shown in FIG. 1 can be marked “stick butter”, and the other side be marked “cube butter”, or other markings can be used to differentiate between the two scales.

FIG. 5 is a top plan view of the cutter 10 in use with a stick 40 of butter which is narrower and longer than the block 24 shown in FIGS. 2 and 3. Its width is “X”, and the width of the blade 16 is wider. Thus, regardless of which size of butter block is being cut, the blade extends almost or completely across the width of the block so that only a single downward thrust of the cutter is necessary to cut the butter.

The purpose of the central slot 22 is to make the food block below the blade 12 visible to facilitate alignment of the block of the measurement marks. Of course, this same purpose can be served by other means, such as by making cut outs or recesses in the edges 18 and 20 of the blade 12 so as to expose the food block to view.

Alternatively, the blade 12 can be made solid but of transparent material through which the food block is visible.

The cutter 10 easily can be molded of thermoplastic material such as ABS. The handle and the blade can be molded separately and secured together mechanically with lock tabs, or with epoxy or ultrasonic welding, etc.

Alternatively, the cutter 10 can be made of stainless steel or other rust-resistant metal by stamping two halves of the handle, one of which is integral with the blade 12, and then welding the two parts together.

It should be evident that the invention amply meets the objectives set forth at the beginning of this specification. The cutter is easy and fast to use, requiring simply to be positioned on the food block, pivoted to an upright position, and then thrust downwardly once to sever the desired quantity from the food block.

The above description of the invention is intended to be illustrative and not limiting. Various changes or modifications in the embodiments described may occur to those skilled in the art. These can be made without departing from the spirit or scope of the invention.

1. A cutter for separating pre-determined quantities of food from a food block, said cutter comprising
(a) a body member with measurement marks on it, said measurement marks being spaced from one another in a first direction, and
(b) a cutting edge extending transversely to said first direction and being spaced from said measurement marks, in which said cutting edge has a length at least substantially equal to the width of said food block in the direction in which it is to be cut.

2. (canceled)

3. A cutter for separating pre-determined quantities of food from a food block, said cutter comprising
(a) a body member with measurement marks on it, said measurement marks being spaced from one another in a first direction, and
(b) a cutting edge extending transversely to said first direction and being spaced from said measurement marks, in which said body member has an opening extending near said marks and in said first direction and positioned to allow at least a portion of said food block to be visible when said cutter is positioned atop said food block.

4. A cutter as in claim 3 in which said body member has side edges and a central portion between said edges and said opening is an elongated slot positioned adjacent said central portion of said body member.

5. A cutter as in claim 1 in which said body member has a plurality of sets of measurement marks, each for use in cutting food blocks of a different size.

6. A cutter as in claim 5 in which said body member has two opposed broad surfaces, one of said sets being located on one of said surfaces, and another set being located on the other of said surfaces.

7. A cutter as in claim 5 in which one of said sets is adapted to provide measurements for a butter block of one regional standard size, and the other of said sets is adapted to provide measurements for another regional standard butter block size.

8. A cutter as in claim 1 in which said body member is relatively wide, whereby said cutter can be used in the manner of a spatula.

9. A method of separating a quantity of food from a food block, said method comprising
(a) selecting a cutter comprising a body member with measurement marks spaced from one another in one direction, and a cutting edge at one end, said cutting edge extending transversely with respect to said one direction and having a length which is substantially equal to or greater than the width of the food block to be cut,
(b) positioning said body member to be substantially parallel to one surface of said food block and aligning one of said measurement marks with said food block, with said cutting edge positioned adjacent said surface of said food block,
(c) pivoting said cutter about said cutting edge to a position in which said body member is transverse to said surface of said block, and
(d) thrusting said cutter onto said bock to separate said quantity from said block.

10. A method as in claim 9 in which said measurement marks include a plurality of sets of marks, one set for each of a plurality of food block sizes, and including the step of selecting the set of marks to be used for the food block to be cut.

11. (canceled)
